(19) United States
(12) Patent Application Publication
(10) Pub. No.: US 2026/0003138 A1
(43) Pub. Date: Jan. 1, 2026

(54) OPTICAL CONNECTION COMPONENT

(71) Applicant: SUMITOMO ELECTRIC INDUSTRIES, LTD., Osaka (JP)

(72) Inventors: Naoki MATSUSHITA, Osaka (JP); Tetsuya NAKANISHI, Osaka (JP); Eiichiro YAMADA, Osaka (JP)

(73) Assignee: SUMITOMO ELECTRIC INDUSTRIES, LTD., Osaka (JP)

(21) Appl. No.: 19/240,612

(22) Filed: Jun. 17, 2025

(30) Foreign Application Priority Data
Jul. 17, 2024 (JP) 2024-114117

(51) Int. Cl. G02B 6/38

(52) U.S. Cl. CPC G02B 6/3887

(57) ABSTRACT

An optical connection component includes a plurality of optical fibers, a boot being provided with a first through hole into which the plurality of optical fibers are inserted, a support member configured to accommodate the boot, and a positioning member being provided with a plurality of holes into each of which an end portion of a corresponding one of the plurality of optical fibers exposed from the boot is inserted. A thermal expansion coefficient of the positioning member is 1×10⁻⁶/K to 1×10⁻⁵/K.

### CROSS REFERENCE TO RELATED APPLICATIONS

This application claims priority based on Japanese Patent Application No. 2024-114117 filed on Jul. 17, 2024, and the entire contents of the Japanese patent application are incorporated herein by reference.

### TECHNICAL FIELD

The present disclosure relates to an optical connection component.

### BACKGROUND

An optical connection component including a plurality of optical fibers and a holding member that holds end portions of the plurality of optical fibers is known (see Patent Literature 1: U.S. Pat. No. 5,619,604 and Patent Literature 2: WO 2020/027125). In such optical connection component, the holding member is fixed to a substrate such as a silicon photonic integrated circuit (Si-PIC) substrate by means of an adhesive.

### SUMMARY

An object of the present disclosure is to provide an optical connection component capable of appropriately transmitting an optical signal.

An optical connection component according to an embodiment of the present disclosure includes a plurality of optical fibers, a boot being provided with a first through hole into which the plurality of optical fibers are inserted, a support member configured to accommodate the boot, and a positioning member being provided with a plurality of holes into each of which an end portion of a corresponding one of the plurality of optical fibers exposed from the boot is inserted. A thermal expansion coefficient of the positioning member is 1×10⁻⁶/K to 1×10⁻⁵/K.

### BRIEF DESCRIPTION OF THE DRAWINGS

FIG. 1 is a perspective view showing an optical connection component according to an embodiment.

FIG. 2 is a cross-sectional view of the optical connection component taken along a line II-II shown in FIG. 1.

FIG. 3 is an enlarged view of a cross-section of the optical connection component shown in FIG. 2.

FIG. 4 is a diagram showing an optical connection component in a state of being fixed to a substrate.

FIG. 5 is a diagram showing a boot shown in FIG. 1.

FIG. 6 is a diagram showing the boot shown in FIG. 1.

FIG. 7 is a diagram showing a positioning member shown in FIG. 1.

### DETAILED DESCRIPTION

However, in a process of fixing a holding member to a substrate, when heat is applied to an optical connection component and the substrate, the optical connection component may peel off from the substrate due to the difference in thermal expansion coefficients between the holding member and the substrate. Further, in the optical connection component, an optical fiber is sometimes used in a bent state for the reason of a low profile (the purpose of reducing the overall height), but the optical fiber may be damaged (disconnected) due to the bending. Such peeling of the optical connection components and damage to the optical fiber may result in inappropriate transmission of optical signal.

### Description of Embodiments of Present Disclosure

First, the contents of embodiments of the present disclosure will be listed and explained.
(1) An optical connection component of the present disclosure includes a plurality of optical fibers, a boot being provided with a first through hole into which the plurality of optical fibers are inserted, a support member configured to accommodate the boot, and a positioning member being provided with a plurality of holes into each of which an end portion of a corresponding one of the plurality of optical fibers exposed from the boot is inserted. A thermal expansion coefficient of the positioning member is 1×10⁻⁶/K to 1×10⁻⁵/K.

The optical connection component includes the boot being provided with the first through hole into which the plurality of optical fibers are inserted. Thus, the boot protects the optical fibers and prevents the optical fibers from being excessively bent, and thus the optical fiber is less likely to be damaged (disconnected). Further, in the optical connection component, the thermal expansion coefficient of the positioning member is 1×10⁻⁶/K to 1×10⁻⁵/K. Thus, it is possible to reduce the difference between the thermal expansion coefficients of the base material (for example, silicon) such as a silicon photonic integrated circuit (Si-PIC) substrate to which the optical connection component is fixed, and the thermal expansion coefficient of the positioning member. This makes it possible to prevent the optical connection component from peeling off from the substrate due to the difference in thermal expansion coefficients between the positioning member and the substrate when heat is applied in a process of fixing the positioning member to the substrate. Thus, according to the optical connection component, it is possible to appropriately transmit an optical signal.
(2) The optical connection component of the above (1) may further include a first adhesive arranged in the plurality of holes and configured to fix the end portion of each of the plurality of optical fibers to the positioning member. In this case, the end portion of each of the plurality of optical fibers are prevented from being misaligned, and thus an optical signal can be transmitted more appropriately.
(3) In the optical connection component of the above (2), the first adhesive may be an ultraviolet-curable adhesive. The positioning member may be made of a material transmitting ultraviolet light. In this case, the first adhesive can be irradiated with ultraviolet light through the positioning member, and thus the optical fiber can be efficiently fixed to the positioning member (curing of the first adhesive). Further, when fixing the optical connection component to another member (for example, a substrate) by means of an ultraviolet-curable adhesive, the adhesive can be irradiated with ultraviolet light through the positioning member, and thus the optical connection component can be efficiently fixed to other members.
(4) In the optical connection component of the above (2) or (3), hardness of the first adhesive may be 80 or more. In this case, the optical fiber can be firmly fixed to the positioning member, and thus the optical fiber can be prevented from falling off from the positioning member.
(5) In the optical connection component according to any one of the above (1) to (4), the positioning member may include a first main surface at which a tip surface of each of the plurality of optical fibers is exposed, and a second main surface located opposite to the first main surface in a first direction, the first direction being a direction in which the end portion of each of the plurality of optical fibers extends. Each of the plurality of holes may be open in the first main surface and the second main surface. An opening of each of the plurality of holes in the second main surface may be larger than an opening of each of the plurality of holes in the first main surface. In this case, the optical fiber can be easily inserted into the hole.
(6) In the optical connection component according to any one of the above (1) to (5), the boot may include a first end surface, and a second end surface located opposite to the first end surface in a first direction, the first direction being a direction in which the end portion of each of the plurality of optical fibers extends. The first through hole may be open in the first end surface and the second end surface. In this case, the optical fiber can be easily inserted into the first through hole.
(7) In the optical connection component according to the above (6), an outer edge of the first end surface may be smaller than an outer edge of the second end surface when viewed in the first direction. In this case, for example, when the support member has a tubular portion, the boot can be easily accommodated in the tubular portion of the support member.
(8) In the optical connection component according to the above (6) or (7), the support member may include a wall portion including a first surface and a second surface located opposite to the first surface in the first direction, and a tubular portion formed on the second surface. The wall portion may be provided with a second through hole into which the plurality of optical fibers are inserted. The boot may be accommodated in the tubular portion such that the first end surface faces the second surface. In this case, the boot can be appropriately protected by the wall portion and the tubular portion which are located so as to surround the boot, and the optical fiber can be exposed to the outside of the support member from the second through hole of the wall portion.
(9) The optical connection component of the above (8) may further include a second adhesive configured to fix the plurality of optical fibers to the support member. The boot may be accommodated in the tubular portion such that a space is formed between the first end surface and the second surface. The second adhesive may be arranged to spread into the second through hole and the space. In this case, the optical fiber is prevented from being misaligned by means of the second adhesive, and thus optical signal can be transmitted more appropriately.
(10) In the optical connection component according to the above (8) or (9), the second through hole may be open in the first surface and the second surface. An opening of the second through hole in the second surface may be larger than an opening of the second through hole in the first surface. In this case, the optical fiber can be easily inserted into the second through hole.
(11) In the optical connection component according to any one of the above (8) to (10), a volume percentage of the boot occupying an internal space of the support member, the internal space being defined by the second surface and an inner surface of the tubular portion, may be 50% to 90%. When the amount of the second adhesive arranged in the space between the first end surface and the second surface is too large, a stress that causes deformation or breakage of the optical connection component may be generated due to shrinkage of the second adhesive upon curing. In the above optical connection component, since the volume percentage of the boot is 50% or more, it is possible to prevent the occurrence of these problems due to the excessive amount of the second adhesive. Further, in the optical connection component, since the volume percentage of the boot is 90% or less, the filling amount of the second adhesive arranged in the space between the first end surface and the second surface can be sufficiently maintained.
(12) In the optical connection component according to any one of the above (8) to (11), the tubular portion may include a third end surface located opposite to the wall portion in the first direction. The third end surface may extend in a loop-like shape so as to surround the boot when viewed in the first direction. A shape of an outer edge of the second end surface may coincide with a shape of an inner edge of the third end surface when viewed in the first direction. In this case, the boot can be prevented from falling off from the support member.
(13) In the optical connection component according to any one of the above (1) to (12), a bending elastic modulus of the boot may be lower than a bending elastic modulus of the support member. In this case, the damage of the optical fiber can be further prevented.
(14) In the optical connection component according to any one of the above (1) to (13), the first through hole may extend in a first direction, the first direction being a direction in which the end portion of each of the plurality of optical fibers extends. A width of the first through hole in a second direction intersecting the first direction may be larger than a width of the first through hole in a third direction intersecting each of the first direction and the second direction. In this case, a row (for example, a ribbon fiber cable) including a plurality of optical fibers arranged in the second direction can be easily inserted into the first through hole. That is, a plurality of optical fibers can be inserted into the first through hole in units of tapes, and the assembly work of the optical connection component can be simplified.
(15) In the optical connection component according to the above (14), the boot may be provided with a plurality of first through holes each of which is the first through hole. The plurality of first through holes may be aligned in the third direction. In this case, the plurality of optical fibers can be arranged in the third direction in an appropriate order. For example, by inserting the plurality of optical fibers into the plurality of first through holes aligned in the third direction, the plurality of optical fibers are less likely to be misaligned or misplaced in the third direction, and each optical fiber can be arranged at an appropriate position.

### Details of Embodiments of Present Disclosure

Specific examples of optical connection components according to the embodiment of the present disclosure will be described below with reference to the drawings. In the following description, the same elements or elements having the same functions are denoted by the same reference numerals, and redundant description will be omitted. The present disclosure is not limited to these examples, but is defined by the scope of the claims, and is intended to include all modifications within the meaning and scope equivalent to the scope of the claims.

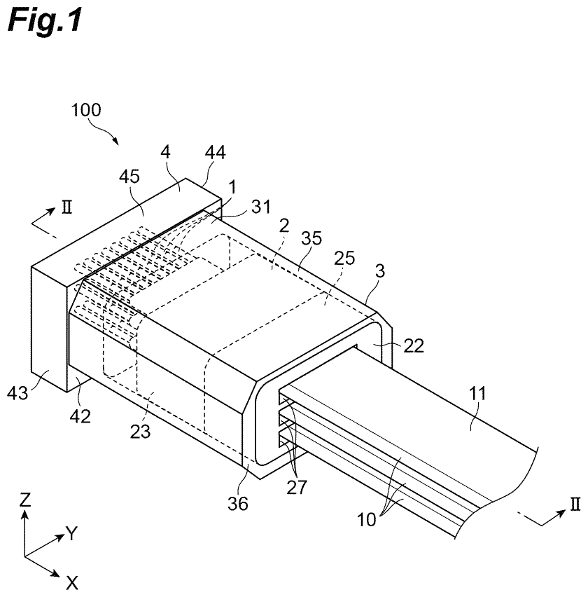

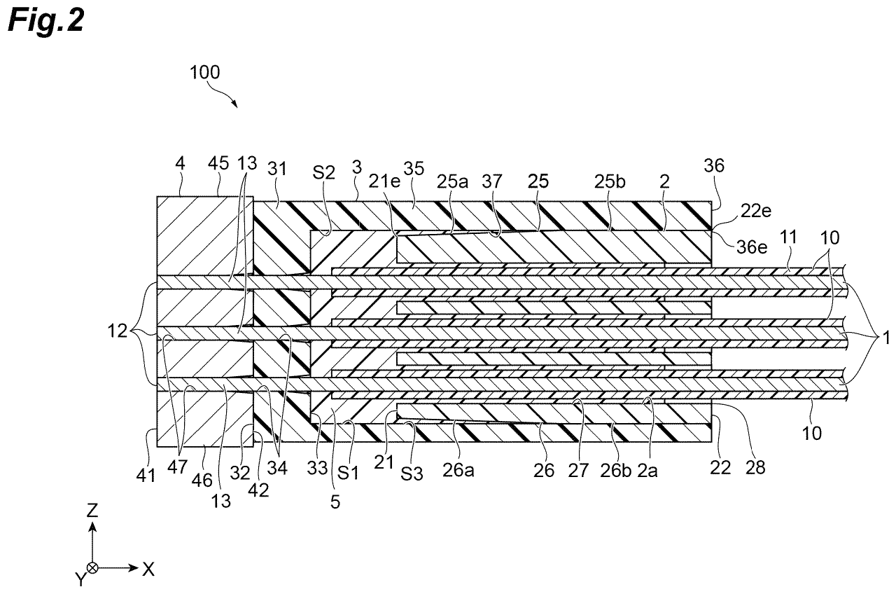

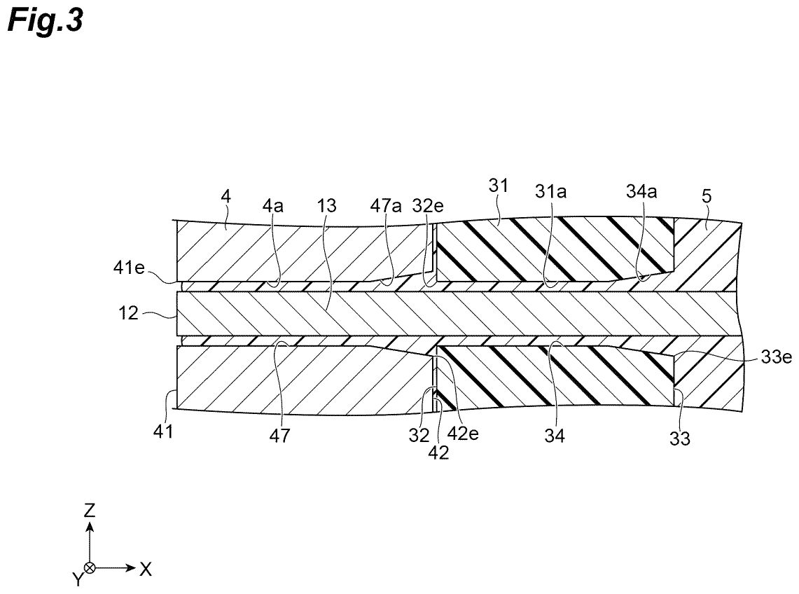

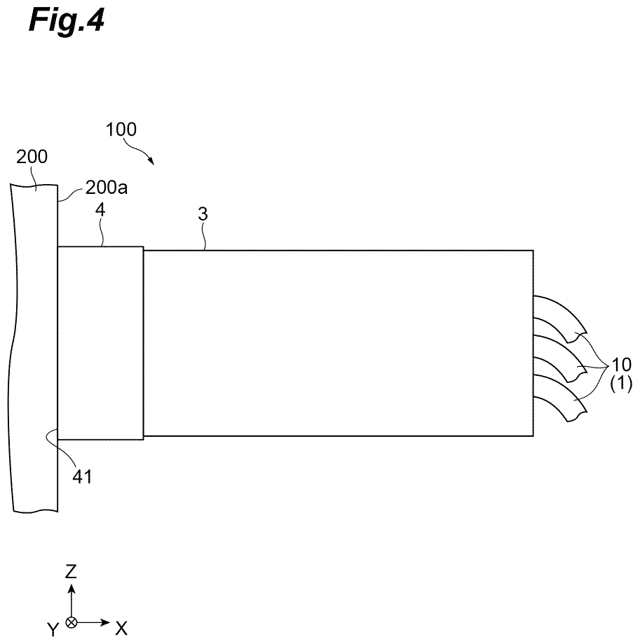

Referring to FIG. 1 to FIG. 4, a configuration of an optical connection component 100 according to an embodiment will be described. FIG. 1 is a perspective view showing the optical connection component 100. FIG. 2 is a cross-sectional view of the optical connection component 100 taken along the line II-II shown in FIG. 1. FIG. 3 is an enlarged view of a cross-section of the optical connection component 100 shown in FIG. 2. FIG. 4 is a diagram showing the optical connection component 100 in a state of being fixed to a substrate 200. The optical connection component 100 includes a plurality of optical fibers 1, a boot 2, a support member 3, and a positioning member 4. Hereinafter, a direction in which end portions 13 of the plurality of optical fibers 1 extend is referred to as an X-axis direction (first direction), a direction intersecting the X-axis direction is referred to as a Y-axis direction (second direction), and a direction intersecting the X-axis direction and the Y-axis direction is referred to as a Z-axis direction (third direction). In this example, the X-axis direction, the Y-axis direction, and the Z-axis direction are orthogonal to each other.

The plurality of optical fibers 1 are arranged in a row. The plurality of optical fibers 1 constitute a plurality of ribbon fiber cables (fiber ribbons) 10. In this example, the optical connection component 100 includes twenty-four optical fibers 1. The eight optical fibers 1 constitute one ribbon fiber cable 10. That is, the optical connection component 100 includes three ribbon fiber cables 10. The end portion of each of the plurality of ribbon fiber cables 10 is arranged in the Z-axis direction. The end portion 13 of each of the plurality of optical fibers 1 included in each ribbon fiber cable 10 is arranged in the Y-axis direction. The end portion 13 of each of optical fibers 1 extends in the X-axis direction.

Each optical fiber 1 has a core and a cladding surrounding the core. The cladding has the refractive index different from that of the core. The ribbon fiber cable 10 has a coating 11 that collectively covers the plurality of optical fibers 1. Each optical fiber 1 includes a portion covered with the coating 11 and a portion not covered with the coating (the coating 11 is removed). The portion not covered with the coating 11 is located closer to a tip surface of each optical fiber 1 than the portion covered with the coating 11.

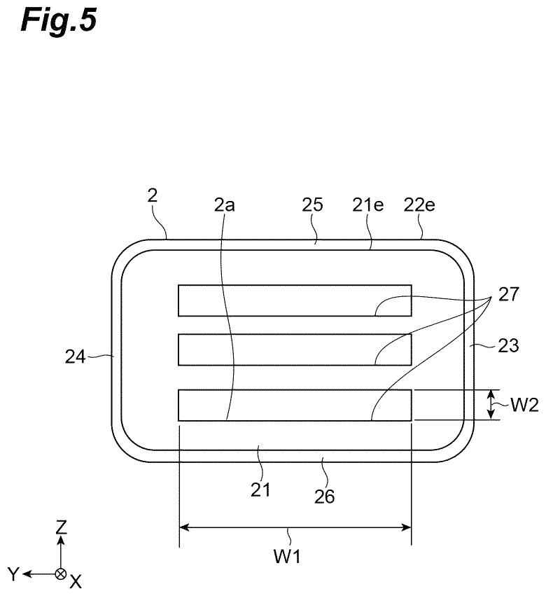

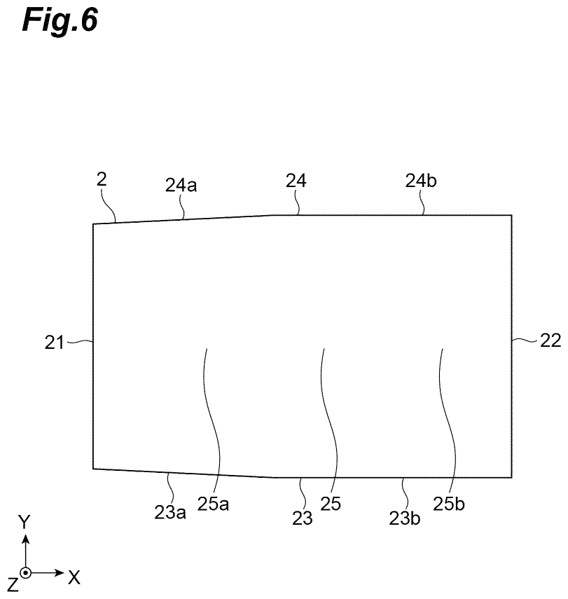

The boot 2 is a member that protects the plurality of optical fibers 1. The detailed configuration of the boot 2 will be described with reference to FIG. 5 and FIG. 6. FIG. 5 is a diagram of the boot 2 when viewed in the X-axis direction. FIG. 6 is a diagram of the boot 2 when viewed in the Z-axis direction. The boot 2 has a substantially rectangular parallelepiped outer shape. The boot 2 has an end surface (first end surface) 21, an end surface (second end surface) 22, a surface 23, a surface 24, a surface 25, and a surface 26. The end surface 22 is located opposite to the end surface 21 in the X-axis direction. Each of the end surface 21 and the end surface 22 extends in the Y-axis direction and the Z-axis direction. The surface 24 is located opposite to the surface 23 in the Y-axis direction. The surface 26 is located opposite to the surface 25 in the Z-axis direction.

The boot 2 has a tapered shape that tapers from the end surface 22 toward the end surface 21. Specifically, the surface 23 includes a portion 23b located closer to the end surface 22 than a portion 23a, and the portion 23a. The surface 24 includes a portion 24b that is located closer to the end surface 22 than a portion 24a, and the portion 24a. The portion 23a and the portion 24a are inclined with respect to the X-axis direction so as to approach each other in the Y-axis direction as they approach the end surface 21 from the end surface 22. The portion 23b and the portion 24b extend in parallel to each other in the X-axis direction and the Z-axis direction.

The surface 25 includes a portion 25b that is located closer to the end surface 22 than a portion 25a, and the portion 25a. The surface 26 includes a portion 26b that is located closer to the end surface 22 than a portion 26a, and the portion 26a. The portion 25a and the portion 26a are inclined with respect to the X-axis direction so as to approach each other in the Z-axis direction as they approach the end surface 21 from the end surface 22. The portion 25b and the portion 26b extend in parallel to each other in the X-axis direction and the Y-axis direction. As shown in FIG. 5, an outer edge 21e of the end surface 21 is smaller than an outer edge 22e of the end surface 22 when viewed in the X-axis direction. When viewed in the X-axis direction, the outer edge 21e is located inside the outer edge 22e.

The boot 2 is provided with a plurality of through holes (first through holes) 27. In this example, three through holes 27 are formed in the boot 2. The plurality of through holes 27 are aligned in the Z-axis direction. Each through hole 27 extends in the X-axis direction. Each through hole 27 is open in the end surface 21 and the end surface 22. Each of the both end portions of the through hole 27 in the X-axis direction is connected to corresponding surface of the end surface 21 and the end surface 22. In this example, when viewed in the X-axis direction, the through hole 27 (an inner surface 2a of the boot 2 that defines each through hole 27) has a rectangular shape having a long side in the Y-axis direction. As shown in FIG. 5, a width W1 of the through hole 27 in the Y-axis direction is larger than a width W2 of the through hole 27 in the Z-axis direction. The plurality of optical fibers 1 (corresponding ribbon fiber cables 10) are inserted into each through hole 27.

The boot 2 is formed of a resin material in which polyphenylene ether and hydrogenated styrene-based thermoplastic elastomer (SEBS) are mixed, for example. The material of the boot 2 may be, for example, FLEX NORYL (trademark) Resin WCP921 from SABIC. The bending elastic modulus (flexural modulus) of the boot 2 is lower than the bending elastic modulus of the support member 3 to be described later. That is, the boot 2 is more flexible than the support member 3. The bending elastic modulus of the boot 2 may be, for example, 150 MPa to 200 MPa, 100 MPa to 250 MPa, or 180 MPa. The bending elastic modulus of the boot 2 is measured in accordance with the ASTM D790 standard. The measurement is performed by placing an object to be measured on two fulcrums and applying a load to the center. The stress and strain that occur as the object bends are measured while the load is increased. From these data, the bending elastic modulus is calculated. The moving speed of a cross-head (moving portion of a machine) during the measurement (speed at which the machine bends the object) is 12.5 mm/min. The length of the support span (distance between the fulcrums) used during measurement is 100 mm.

The support member 3 is a member that is configured to accommodate the boot 2. The support member 3 has a wall portion 31 and a tubular portion 35. The wall portion 31 is a plate-shaped member extending in the Y-axis direction and the Z-axis direction. The wall portion 31 has a surface 32 and a surface 33. The surface 32 and the surface 33 extend in the Y-axis direction and the Z-axis direction. The surface 33 is located opposite to the surface 32 in the X-axis direction.

The wall portion 31 is provided with a plurality of through holes (second through holes) 34. In this example, twenty-four through holes 34 are formed in the wall portion 31. Eight through holes 34 are aligned in the Y-axis direction, and three through holes 34 are aligned in the Z-axis direction. Three rows each including eight through holes 34 aligned in the Y-axis direction are aligned in the Z-axis direction. Each through hole 34 extends through the wall portion 31 in the X-axis direction. Each through hole 34 is open in the surface 32 and the surface 33. Each of the both end portions of the through hole 34 in the X-axis direction is connected to the corresponding surface of the surface 32 and the surface 33. In this example, when viewed in the X-axis direction, the through holes 34 (the inner surfaces 31a of the wall portion 31 that defines each through holes 34) has a circular shape. The difference obtained by subtracting a diameter of the optical fiber 1 from the diameter of each through hole 34 may be, for example, 2 μm or less.

As shown in FIG. 3, the through hole 34 (inner surface 31a) includes a tapered portion 34a. In the tapered portion 34a, the diameter of the through hole 34 decreases from the surface 33 toward the surface 32. The tapered portion 34a is connected to the surface 33. An opening 33e of the through hole 34 in the surface 33 is larger than an opening 32e of the through hole 34 in the surface 32. When viewed in the X-axis direction, each through hole 34 overlaps with the corresponding through hole 27. The end portion 13 of each of the plurality of optical fibers 1 exposed from the boot 2 is inserted into each of the plurality of through holes 34. A portion of the optical fiber 1 from which the coating 11 has been removed is inserted into each through hole 34.

The tubular portion 35 is formed on the surface 33 of the wall portion 31. The tubular portion 35 is formed integrally with the wall portion 31, meaning that they are connected together. The tubular portion 35 extends continuously along an outer edge of the surface 33 such that a space (internal space) S1 is formed within the tubular portion 35. The tubular portion 35 has an end surface (third end surface) 36 located opposite to the wall portion 31 in the X-axis direction. An end surface 36 extends in a loop-like shape so as to surround the boot 2 when viewed in the X-axis direction.

The support member 3 is formed of a resin material such as a liquid crystal polymer (LCP). The material of the support member 3 may be, for example, LAPEROS (trademark) LCP E130i from Polyplastics Co., Ltd. The bending elastic modulus of the support member 3 is higher than the bending elastic modulus of the boot 2. The bending elastic modulus of the support member 3 may be, for example, 12000 MPa to 18000 MPa, or 10000 MPa to 20000 MPa. The bending elastic modulus of the support member 3 is measured in accordance with the ISO 178 standard. When the bending elastic modulus of the boot 2 and the bending elastic modulus of the support member 3 are compared, these bending elastic modulus are measured by a common measurement method (measurement condition). The standard to which the measurement method is in accordance may be taken from any of the ASTM D790 standard and the ISO 178 standard, for example.

The boot 2 is accommodated in the space S1. The space S1 is defined by the surface 33 of the wall portion 31 and an inner surface 37 of the tubular portion 35. The boot 2 is inserted into the space S1 through the opening in the end surface 36 of the tubular portion 35. The boot 2 is accommodated in the space S1 such that the end surface 21 faces the surface 33. The boot 2 is accommodated in the tubular portion 35 such that a space S2 (gap) is formed between the end surface 21 and the surface 33. A volume percentage of the boot 2 occupying the space S1 may be 50% to 90%, 60% to 80%, or 72%. The volume of the boot 2 includes the volume of the inside of the through hole 27.

In this example, the boot 2 is accommodated in the space S1 such that the end surface 22 is on the same plane as the end surface 36, that is, there is no step and the surfaces are aligned (such that positions in the X-axis direction are the same as each other.). When viewed in the X-axis direction, a shape of the outer edge 22e of the end surface 22 coincides with a shape of an inner edge 36e of the end surface 36. The term “the shape of the outer edge 22e coincides with the shape of the inner edge 36e” means that no gap is formed between the inner edge 36e and the outer edge 22e. The portion 23a, the portion 24a, the portion 25a, and the portion 26a are not in contact with the inner surface 37 of the tubular portion 35, and are separated from the inner surface 37. A space (gap) S3 is formed between the inner surface 37 and each of the portion 23a, the portion 24a, the portion 25a, and the portion 26a. The portion 23b, the portion 24b, the portion 25b, and the portion 26b are in contact with the inner surface 37 of the tubular portion 35.

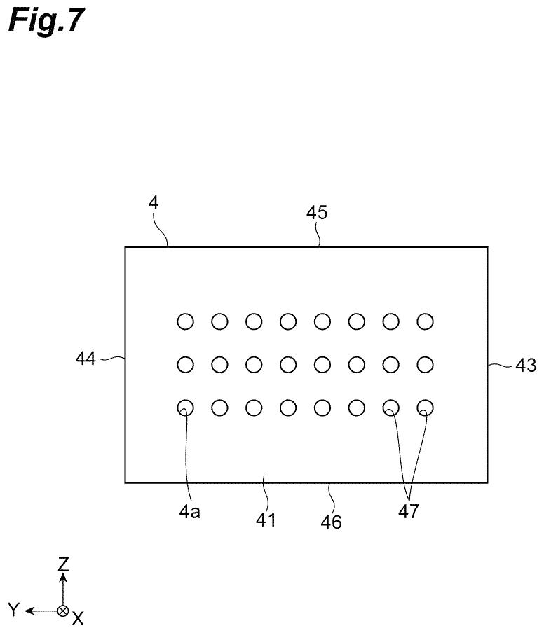

The positioning member 4 is a member that holds the end portions 13 of the plurality of optical fibers 1 and determines the positions of the end portions 13. The detailed configuration of the positioning member 4 will be described with reference to FIG. 7. FIG. 7 is a diagram of the positioning member 4 as viewed in the X-axis direction. The positioning member 4 has a substantially rectangular plate shape. The thickness direction of the positioning member 4 is along the X-axis direction, the long side direction is along the Y-axis direction, and the short side direction is along the Z-axis direction. The positioning member 4 has a main surface (first main surface) 41, a main surface (second main surface) 42, a surface 43, a surface 44, a surface 45, and a surface 46. The main surface 42 is located opposite to the main surface 41 in the X-axis direction. Each of the main surface 41 and the main surface 42 extends in the Y-axis direction and the Z-axis direction. The surface 44 is located opposite to the surface 43 in the Y-axis direction. Each of the surface 43 and the surface 44 extends in the X-axis direction and the Z-axis direction. The surface 46 is located opposite to the surface 45 in the Z-axis direction. Each of the surface 45 and the surface 46 extends in the X-axis direction and the Y-axis direction.

The positioning member 4 is provided with a plurality of holes 47. In this example, twenty-four holes 47 are formed in the positioning member 4. Eight holes 47 are aligned in the Y-axis direction, and three holes 47 are aligned in the Z-axis direction. Three rows each including eight holes 47 aligned in the Y-axis direction are aligned in the Z-axis direction. Each of the holes 47 extends through the positioning member 4 in the X-axis direction. Each of the holes 47 is open in the main surface 41 and the main surface 42. Each of the both end portions of the hole 47 in the X-axis direction is connected to the corresponding surface of the main surface 41 and the main surface 42. In this example, when viewed in the X-axis direction, the hole 47 (an inner surface 4a of the positioning member 4 that defines each hole 47) has a circular shape. The difference obtained by subtracting the diameter of the optical fiber 1 from the diameter of each hole 47 may be, for example, 2 μm or less.

As shown in FIG. 3, the hole 47 (inner surface 4a) includes a tapered portion 47a. In the tapered portion 47a, the diameter of the hole 47 decreases from the main surface 42 toward the main surface 41. The tapered portion 47a is connected to the main surface 42. An opening 42e of the hole 47 in the main surface 42 is larger than an opening 41e of the hole 47 in the main surface 41. When viewed in the X-axis direction, each hole 47 overlaps with the corresponding through hole 27 and the through hole 34. The end portion 13 of a corresponding one of the plurality of optical fibers 1 exposed from the boot 2 is inserted into each of the plurality of holes 47. A portion of the optical fiber 1 from which the coating 11 has been removed is inserted into each hole 47. A tip surface 12 of each of the plurality of optical fibers 1 are exposed from the main surface 41 to the outside of the positioning member 4.

The positioning member 4 is formed of a glass material such as borosilicate glass. The material of the positioning member 4 may be, for example, BOROFLOAT glass from SCHOTT. When the positioning member 4 is formed of a hard material such as glass, the positioning accuracy of the optical fiber 1 can be improved. In this example, the positioning member 4 is made of a material transmitting ultraviolet light. The ultraviolet light transmissivity of the positioning member 4 with respect to ultraviolet light having wavelengths of 315 nm to 400 nm may be 70% or more. The thermal expansion coefficient of the positioning member 4 is 1×10⁻⁶/K to 1×10⁻⁵/K. The thermal expansion coefficient of the positioning member 4 may be 2×10⁻⁶/K to 5×10⁻⁶/K, or may be 3.25×10⁻⁶/K. The term “the thermal expansion coefficient of the positioning member 4” means that an average thermal expansion coefficient of the positioning member 4 from 20° C. to 300° C. The thermal expansion coefficient of the positioning member 4 is measured by, for example, the method of JIS R 3102.

The optical connection component 100 includes an adhesive 5. The adhesive 5 is arranged to spread into the space S2, the space S3, the plurality of through holes 27, the plurality of through holes 34, a space between the surface 32 and the main surface 42, and the plurality of holes 47. A portion (second adhesive) of the adhesive 5 arranged to spread into the space S2 and the plurality of through holes 34 fixes the plurality of optical fibers 1 to the support member 3. A portion of the adhesive 5 arranged in the space S3 fixes the boot 2 to the support member 3. A portion of the adhesive 5 arranged in the plurality of through holes 27 fixes the plurality of optical fibers 1 to the boot 2. A portion of the adhesive 5 arranged in the surface 32 and the main surface 42 fixes the support member 3 to the positioning member 4. A portion (first adhesive) of the adhesive 5 arranged in the plurality of holes 47 fixes the end portions 13 of the plurality of optical fibers 1 to the positioning member 4.

For example, the adhesive 5 may be injected to the inside (space S2) of the support member 3 and then flow into the space S3, the plurality of through holes 27, the plurality of through holes 34, the space between the surface 32 and the main surface 42, and the plurality of holes 47. The adhesive 5 does not reach openings 28 of the plurality of through holes 27 in the end surface 22. Thus, even when a portion of the ribbon fiber cable 10 exposed to the outside of the boot 2 from the opening 28 is bent, the bent portion does not come into contact with the adhesive 5 in the opening 28. Thus, when the cured adhesive 5 is harder (when the bending elastic modulus or Young's modulus is higher) than the boot 2, the bent portion of the ribbon fiber cable 10 can be prevented from being damaged by coming into contact with the adhesive 5.

The material of the adhesive 5 may be a resin such as epoxy. The adhesive 5 may be, for example, an EPO-TEK 353ND or an NTT-AT EH4197. The hardness of the adhesive 5 may be 80 or more. The term “the hardness of the adhesive 5” means that the hardness of the adhesive 5 in a state after being cured. The hardness of the adhesive 5 is measured by Type D Durometer. The adhesive 5 is an ultraviolet-curable adhesive. The adhesive 5 is a thermosetting adhesive. The adhesive 5 may be cured in the following flow. That is, since the positioning member 4 is made of a material transmitting ultraviolet light, the portion of the adhesive 5 arranged in the hole 47 can be irradiated with ultraviolet light through the positioning member 4. Thus, first, the portions of the adhesive 5 arranged in the plurality of holes 47 may be cured (temporarily fixed) by ultraviolet light irradiation through the positioning member 4. Subsequently, the entire adhesive 5, including the other portions may be heated to be completely cured (complete curing).

As shown in FIG. 4, the optical connection component 100 is fixed to the substrate 200. In this example, the substrate 200 is a silicon photonic integrated circuit (Si-PIC) substrate. The Si-PIC substrate is a substrate in which silicon is used as a base material. Elements and circuits for processing optical signals are integrated on the substrate 200. In a state where the optical connection component 100 is fixed to the substrate 200, the optical fibers 1 and the elements mounted on the substrate 200 are optically connected, and optical signals are transmitted between them.

The thermal expansion coefficient of the substrate 200 is 2×10⁻⁶/K to 5×10⁻⁶/K. The term “the thermal expansion coefficient of the substrate 200” means that an average thermal expansion coefficient of the base material (silicon in this example) of the substrate 200 from 20° C. to 300° C. The thermal expansion coefficient of the substrate 200 is measured by a thermal dilatometer. As described above, the thermal expansion coefficient of the positioning member is 1×10⁻⁶/K to 1×10⁻⁵/K. That is, the thermal expansion coefficient of the substrate 200 and the thermal expansion coefficient of the positioning member 4 are both approximately 10⁻⁶/K order, and the difference between them is small.

The optical connection component 100 is disposed on the substrate 200 such that the main surface 41 of the positioning member 4 faces a main surface 200a of the substrate 200. An adhesive may be arranged between the main surface 41 and the main surface 200a, and the optical connection component 100 may be fixed to the substrate 200 by means of the adhesive. In a process of fixing the optical connection component 100 (the positioning member 4) to the substrate 200, a heat treatment may be performed on the optical connection component 100 and the substrate 200. The optical connection component 100 may be used in a state where the plurality of optical fibers 1 (the plurality of ribbon fiber cables 10) are bent. In this case, the ribbon fiber cable 10 may be in contact with the boot 2 (specifically, the inner surface 2a of the boot 2 that defines the through hole 27).

As described above, the optical connection component 100 includes the boot 2 being provided with the through hole 27 into which the plurality of optical fibers 1 are inserted. Thus, the boot 2 protects the optical fiber 1 and prevents the optical fiber 1 from being excessively bent, and thus the optical fiber 1 is less likely to be damaged (disconnected). In the optical connection component 100, the thermal expansion coefficient of the positioning member 4 is 1×10⁻⁶/K to 1×10⁻⁵/K. Thus, it is possible to reduce the difference between the thermal expansion coefficients of the base material (silicon) of the silicon photonic integrated circuit (Si-PIC) substrate to which the optical connection component 100 is fixed and the thermal expansion coefficient of the positioning member 4. This makes it possible to prevent the optical connection component 100 from peeling off from the substrate 200 due to the difference in thermal expansion coefficients between the positioning member 4 and the substrate 200 when heat is applied in a process of fixing the positioning member 4 to the substrate 200. Thus, according to the optical connection component 100, it is possible to appropriately transmit the optical signal.

The optical connection component 100 includes the adhesive 5 arranged in the plurality of holes 47 and configured to fix the end portions 13 of each of the plurality of optical fibers 1 to the positioning member 4. Thus, the end portions 13 of the plurality of optical fibers 1 are prevented from being misaligned, and optical signals can be transmitted more appropriately.

The adhesive 5 is an ultraviolet-curable adhesive. The positioning member 4 is made of a material transmitting ultraviolet light. Thus, the adhesive 5 can be irradiated with ultraviolet light through the positioning member 4, and thus the optical fiber 1 can be efficiently fixed to the positioning member 4 (curing of the adhesive 5). Further, when fixing the optical connection component 100 to the substrate 200 by means of an ultraviolet-curable adhesive, the adhesive placed between the positioning member 4 and the substrate 200 can be irradiated with ultraviolet light through the positioning member 4, and thus the optical connection component 100 can be efficiently fixed to the substrate 200.

The hardness of the adhesive 5 is 80 or more. Thus, the optical fiber 1 can be firmly fixed to the positioning member 4, and thus the optical fiber 1 can be prevented from falling off from the positioning member 4.

The positioning member 4 has the main surface 41 at which the tip surface of each of the plurality of optical fibers 1 is exposed, and the main surface 42 located opposite to the main surface 41 in the X-axis direction. Each of the plurality of holes 47 is open in the main surface 41 and the main surface 42. The opening 42e of each of the plurality of holes 47 in the main surface 42 is larger than the opening 41e of each of the plurality of holes 47 in the main surface 41. Thus, the optical fiber 1 can be easily inserted into the hole 47.

The boot 2 has the end surface 21 and the end surface 22 located opposite to the end surface 21 in the X-axis direction. The through hole 27 is open in the end surface 21 and the end surface 22. Thus, the optical fiber 1 can be easily inserted into the through hole 27.

The outer edge 21e of the end surface 21 is smaller than the outer edge 22e of the end surface 22 when viewed in the X-axis direction. Thus, the boot 2 can be easily accommodated in the tubular portion 35 of the support member 3.

The support member 3 includes the wall portion 31 having the surface 33 located opposite to the surface 32 in the X-axis direction and the surface 32, and the tubular portion 35 formed on the surface 33. The wall portion 31 is provided with the through hole 34 into which the plurality of optical fibers 1 are inserted. The boot 2 is accommodated in the tubular portion 35 such that the end surface 21 faces the surface 33. Thus, the boot 2 can be appropriately protected by the wall portion 31 and the tubular portion 35 which are located so as to surround the boot 2, and the optical fiber 1 can be exposed to the outside of the support member 3 from the through hole 34 of the wall portion 31.

The optical connection component 100 includes the adhesive 5 configured to fix the plurality of optical fibers 1 to the support member 3. The boot 2 is accommodated in the tubular portion 35 such that the space S2 is formed between the end surface 21 and the surface 33. The adhesive 5 is arranged to spread into the through hole 34 and the space S2. Thus, the optical fiber 1 is prevented from being misaligned by means of the adhesive 5, and thus optical signals can be transmitted more appropriately.

The through hole 34 is open in the surface 32 and the surface 33, and the opening 33e of the through hole 34 in the surface 33 is larger than the opening 32e of the through hole 34 in the surface 32. Thus, the optical fiber 1 can be easily inserted into the through hole 34.

The volume percentage of the boot 2 occupying the space S1 of the support member 3 which is defined by the surface 33 and the inner surface of the tubular portion 35 is 50% to 90%. When the amount of the adhesive 5 arranged in the space S2 between the end surface 21 and the surface 33 is too large, a stress that causes deformation or breakage of the optical connection component 100 may be generated due to shrinkage of the adhesive 5 upon curing. In the optical connection component 100, since the volume percentage of the boot 2 is 50% or more, it is possible to prevent the occurrence of these problems due to the excessive amount of the adhesive 5. Further, in the optical connection component 100, since the volume percentage of the boot 2 is 90% or less, the filling amount of the adhesive 5 arranged in the space S2 can be sufficiently maintained.

The tubular portion 35 has the end surface 36 located opposite to the wall portion 31 in the X-axis direction. The end surface 36 extends in a loop-like shape so as to surround the boot 2 when viewed in the X-axis direction. The shape of the outer edge 22e of the end surface 22 coincides with the shape of the inner edge 36e of the end surface 36 when viewed in the X-axis direction. Thus, the boot 2 can be prevented from falling off from the support member 3.

The bending elastic modulus of the boot 2 is lower than the bending elastic modulus of the support member 3. Thus, the damage of the optical fiber 1 can be further prevented.

The through hole 27 extends in the X-axis direction. The width W1 of the through hole 27 in the Y-axis direction is larger than the width W2 of the through hole 27 in the Z-axis direction. Thus, a row (for example, a ribbon fiber cable) including the plurality of optical fibers 1 arranged in the Y-axis direction can be easily inserted into the through hole 27. That is, the plurality of optical fibers 1 can be inserted into the through hole 27 in units of tapes, and the assembly work of the optical connection component 100 can be simplified.

The boot 2 is provided with the plurality of through holes 27. The plurality of through holes 27 are aligned in the Z-axis direction. Thus, the plurality of optical fibers 1 can be arranged in the Z-axis direction in an appropriate order. For example, by inserting the plurality of optical fibers 1 into the plurality of through holes 27 aligned in the Z-axis direction, the plurality of optical fibers 1 are less likely to be misaligned or misplaced in the Z-axis direction, and each optical fiber 1 can be arranged at an appropriate position.

Although the embodiments have been described above, the present disclosure is not necessarily limited to the above-described embodiments, and various modifications can be made without departing from the scope of the present disclosure. Further, the above embodiments may be combined as appropriate.

The boot 2 does not have to have a tapered shape that tapers from the end surface 22 toward the end surface 21. The outer edge shape of the boot 2 in the cross-section perpendicular to the Y-axis direction may be constant. When viewed in the X-axis direction, the shape of the outer edge 21e of the end surface 21 may be the same as the shape of the outer edge 22e of the end surface 22. When viewed in the X-axis direction, the outer edge 21e of the end surface 21 may be larger than the outer edge 22e of the end surface 22. When viewed in the X-axis direction, the shape of the outer edge 22e of the end surface 22 does not have to coincide with the shape of the inner edge 36e of the end surface 36. A gap may be formed between the inner edge 36e and the outer edge 22e.

The end surface 22 does not have to be on the same plane as the end surface 36, that is, the end surface 22 does not have to be flush with the end surface 36 and there may be a step between the surfaces. The boot 2 may be accommodated in the space S1 such that the end surface 22 is located closer to the wall portion 31 than the end surface 36 (such that the entire boot 2 is located inside the space S1). The boot 2 may be accommodated in the space S1 such that the end surface 22 is located farther from the wall portion 31 than the end surface 36 (such that the end surface 22 of the boot 2 is located outside the space S1).

The space S2 does not have to be formed. That is, the boot 2 may be accommodated in the space S1 such that the end surface 21 is in contact with the surface 33. The volume percentage of the boot 2 occupying the space S1 may be smaller than 50% or larger than 90%.

The through hole 34 (inner surface 31a) does not have to include the tapered portion 34a. The diameter of the through hole 34 may be constant. The size of the opening 33e of the through hole 34 in the surface 33 may be the same as the size of the opening 32e of the through hole 34 in the surface 32. The size of the opening 33e may be smaller than that of the opening 32e.

The positioning member 4 does not have to be made of a material transmitting ultraviolet light. The hole 47 (inner surface 4a) does not have to include the tapered portion 47a. The diameter of the hole 47 may be constant. The size of the opening 42e of the hole 47 in the main surface 42 may be the same as the size of the opening 41e of the hole 47 in the main surface 41. The opening 42e may be smaller than the opening 41e.

Among the adhesives 5, at least one of the portion arranged in the space S2, the portion arranged in the space S3, the portion arranged in the plurality of through holes 27, the portion arranged in the plurality of through holes 34, the portion arranged between the surface 32 and the main surface 42, or the portion arranged in the plurality of holes 47 may be omitted or may be separated from the other portions. For example, the portion (first adhesive) of the adhesive 5 arranged in the plurality of holes 47 may be separated from the portion (second adhesive) of the adhesive 5 arranged to spread into the space S2 and the plurality of through holes 34.

The adhesive 5 does not have to be an ultraviolet-curable adhesive. The adhesive 5 does not have to be a thermosetting adhesive. The hardness of the adhesive 5 may be less than 80. Each of the number of the through holes 27 formed in the boot 2, the number of the through holes 34 formed in the support member 3, and the number of the holes 47 formed in the positioning member 4 is not limited, receptively.

What is claimed is:

1. An optical connection component comprising:
a plurality of optical fibers;
a boot being provided with a first through hole into which the plurality of optical fibers are inserted;
a support member configured to accommodate the boot; and
a positioning member being provided with a plurality of holes into each of which an end portion of a corresponding one of the plurality of optical fibers exposed from the boot is inserted,
wherein a thermal expansion coefficient of the positioning member is 1×10⁻⁶/K to 1×10⁻⁵/K.

2. The optical connection component according to claim 1, further comprising:
a first adhesive arranged in the plurality of holes and configured to fix the end portion of each of the plurality of optical fibers to the positioning member.

3. The optical connection component according to claim 2,
wherein the first adhesive is an ultraviolet-curable adhesive, and
wherein the positioning member is made of a material transmitting ultraviolet light.

4. The optical connection component according to claim 2,
wherein hardness of the first adhesive is 80 or more.

5. The optical connection component according to claim 1,
wherein the positioning member includes
a first main surface at which a tip surface of each of the plurality of optical fibers is exposed, and
a second main surface located opposite to the first main surface in a first direction, the first direction being a direction in which the end portion of each of the plurality of optical fibers extends,
wherein each of the plurality of holes is open in the first main surface and the second main surface, and
wherein an opening of each of the plurality of holes in the second main surface is larger than an opening of each of the plurality of holes in the first main surface.

6. The optical connection component according to claim 1,
wherein the boot includes
a first end surface, and
a second end surface located opposite to the first end surface in a first direction, the first direction being a direction in which the end portion of each of the plurality of optical fibers extends, and
wherein the first through hole is open in the first end surface and the second end surface.

7. The optical connection component according to claim 6,
wherein an outer edge of the first end surface is smaller than an outer edge of the second end surface when viewed in the first direction.

8. The optical connection component according to claim 6,
wherein the support member includes
a wall portion including a first surface and a second surface located opposite to the first surface in the first direction, and
a tubular portion formed on the second surface,
wherein the wall portion is provided with a second through hole into which the plurality of optical fibers are inserted, and
wherein the boot is accommodated in the tubular portion such that the first end surface faces the second surface.

9. The optical connection component according to claim 8, further comprising:
a second adhesive configured to fix the plurality of optical fibers to the support member,
wherein the boot is accommodated in the tubular portion such that a space is formed between the first end surface and the second surface, and
wherein the second adhesive is arranged to spread into the second through hole and the space.

10. The optical connection component according to claim 8,
wherein the second through hole is open in the first surface and the second surface, and
wherein an opening of the second through hole in the second surface is larger than an opening of the second through hole in the first surface.

11. The optical connection component according to claim 8,
wherein a volume percentage of the boot occupying an internal space of the support member, the internal space being defined by the second surface and an inner surface of the tubular portion, is 50% to 90%.

12. The optical connection component according to claim 8,
wherein the tubular portion includes a third end surface located opposite to the wall portion in the first direction,
wherein the third end surface extends in a loop-like shape so as to surround the boot when viewed in the first direction, and
wherein a shape of an outer edge of the second end surface coincides with a shape of an inner edge of the third end surface when viewed in the first direction.

13. The optical connection component according to claim 1,
wherein a bending elastic modulus of the boot is lower than a bending elastic modulus of the support member.

14. The optical connection component according to claim 1,
wherein the first through hole extends in a first direction, the first direction being a direction in which the end portion of each of the plurality of optical fibers extends, and
wherein a width of the first through hole in a second direction intersecting the first direction is larger than a width of the first through hole in a third direction intersecting each of the first direction and the second direction.

15. The optical connection component according to claim 14,
wherein the boot is provided with a plurality of first through holes each of which is the first through hole, and
wherein the plurality of first through holes are aligned in the third direction.
